(19) United States
(12) Patent Application Publication
(10) Pub. No.: US 2018/0216519 A1
(43) Pub. Date: Aug. 2, 2018

(54) Multiple Turbulator Heat Exchanger

(71) Applicant: GM Global Technology Operations LLC, Detroit, MI (US)

(72) Inventors: Jeffrey S. Davis, Howell, MI (US); Prakash R. Patel, Rochester Hills, MI (US)

(21) Appl. No.: 15/423,099

(22) Filed: Feb. 2, 2017

(51) Int. Cl. F02B 29/04; F28D 1/02; F28D 1/03

(52) U.S. Cl. CPC F02B 29/0425; F28D 1/0366; F28D 1/024; F02B 29/0456

(57) ABSTRACT

The present disclosure relates to an air-to-air charge air cooler (CAC) for cooling air supplied to an internal combustion engine. The CAC may have a housing and a plurality of trays located in the housing. A first one of the trays may include a first turbulator having a first internal configuration. A second one of the trays may include a second turbulator having a second internal configuration different from the first internal configuration.

### FIELD

The present disclosure relates to heat exchangers, and more particularly to a heat exchanger having different types of turbulators.

### BACKGROUND

The background description provided here is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

Automotive vehicles use engines with turbochargers to increase power and reduce fuel consumption. A heat exchanger in the form of an air-to-air charge air cooler (“CAC”) is often used to cool compressed air generated by the turbocharger before the compressed air is fed into an intake manifold of the engine. Cooling of the compressed air increases the density of the air, which increases the efficiency of the engine.

The CAC includes a plurality of independent tubes through which the compressed air flows. The CAC is usually located at the front of the vehicle so that ambient air passes over the tubes as the vehicle is driven. A separate turbulator may be disposed inside each of the tubes. The turbulators act as heat sinks to help dissipate heat from the compressed air produced by the turbocharger. However, it is important that moisture in the air fed into the CAC does not condense in the CAC. The moisture reduces engine performance if the liquid migrates into the combustion chambers of the engine. At low temperatures, the moisture can freeze and cause blockage of some of the flow paths through the CAC. If the moisture freezes, it can also lead to cracking of the CAC. This can lead to leakage of compressed air from the CAC, reducing efficiency of the engine.

The size of the CAC can be increased to increase cooling capacity. However, increasing the size of the CAC impacts surrounding components within the engine compartment due to the limited space available. A coolant-to-air heat exchanger system is another option to increase cooling capacity. However, coolant-to-air heat exchangers are more costly, heavier than CAC type heat exchangers, and often involve more components than air-to-air CACs.

### SUMMARY

In one aspect the present disclosure relates to an air air-to-air charge air cooler (CAC) for cooling air supplied to an internal combustion engine. The CAC may comprise a housing and a plurality of trays located in the housing. A first one of the trays may include a first turbulator having a first internal configuration. A second one of the trays may include a second turbulator having a second internal configuration different from the first internal configuration.

In another aspect the present disclosure relates to an air-to-air charge air cooler (CAC) for cooling air supplied to an internal combustion engine. The CAC may comprise a housing. A plurality of trays may be located in the housing. A first one of the trays may include a lanced-offset turbulator. A second one of the trays may include a smooth style turbulator.

In still another aspect the present disclosure relates to an air-to-air charge air cooler (CAC) for cooling air supplied to an internal combustion engine. The CAC may comprise a housing and a plurality of trays located in the housing. Each one of a first subplurality of the trays may include a separate lanced-offset turbulator. Each one of a second subplurality of the trays, different from the first subplurality of trays, may include a separate smooth style turbulator.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of a CAC according to the present disclosure;

FIG. 2 is a cross sectional view of a left most section of the CAC of FIG. 3 taken in accordance with section line 2-2 in FIG. 1;

FIG. 3 is a plan view in accordance with directional line 3 in FIG. 2 illustrating one embodiment of the locations of the different types of turbulators used in the CAC; and

FIG. 4 is a plan view of another embodiment of the CAC having lanced-offset and smooth style turbulators arranged in an alternating fashion within a housing of the CAC.

In the drawings, reference numbers may be reused to identify similar and/or identical elements.

### DETAILED DESCRIPTION

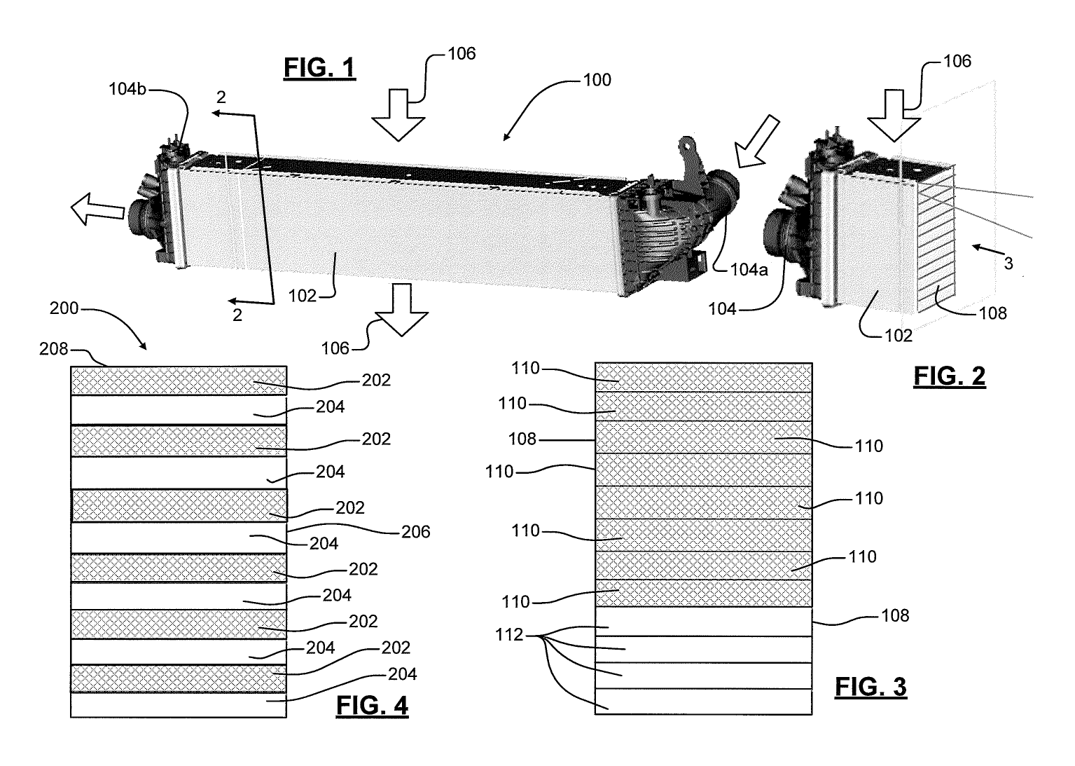

Referring now to FIG. 1, one embodiment of an air-to-air charge air cooler (CAC) 100 of the present disclosure for use in cooling air supplied to an intake manifold of an internal combustion engine of a motor vehicle. The CAC 100 includes a housing 102, an inlet structure 104a associated with the housing for coupling to an external conduit or hose through which compressed air from a turbocharger is delivered to the CAC. An outlet structure 104b is attached to the housing 102 through which the compressed air travelling through the CAC 100 is discharged to an intake manifold of the engine. Hot compressed air from a turbocharger of the engine is directed into the CAC 100 and cooled in the CAC before being discharged. The cooling is achieved with the aid of ambient airflow 106 flowing into and through the CAC 100.

Referring now to FIG. 2, the housing 102 encloses a plurality of independent rectangular trays 108 through which the ambient airflow 106 flows. Each tray 108 includes a selected type of turbulator, for example either a smooth type turbulator or a lanced-offset turbulator. The trays 108 may be held removably within the housing 102 or they may be permanently installed in the housing such as by welding.

In FIG. 3, shaded sections of the trays 108 represent trays where lanced-offset turbulators 110 are installed, and unshaded sections represent trays 108 where smooth style turbulators 112 are installed. The number of each style of turbulator 110 or 112 may depend on the specific vehicle/engine application. While the turbulators 110 and 112 are shown as being segregated into two distinct groups, other configurations are possible. For example, the CAC 100 may use an alternating pattern of the turbulators 110 and 112 so that no two adjacent trays 108 have the same style of turbulator 110 or 112.

Referring now to FIG. 4, a CAC 200 includes alternately positioned lanced-offset turbulators 202 and smooth style turbulators 204 in a stack of trays 206 within a housing 208. The lanced-offset turbulators 202 and the smooth style turbulators 204 may be configured into virtually any pattern or grouping that suits the needs of a particular engine/vehicle application. For example, alternating groups of two lanced-offset turbulators 202 and three smooth style turbulators 204 could be provided. Still further one lanced-offset turbulator 202 could be located between groups of two or more smooth style turbulators 204.

Using two different types of turbulators in the CAC 100 or 200 provides a number of benefits. For example, the CAC 100 or 200 may provide improved cooling performance over a prior art CAC of the same size that has all smooth style turbulators without significantly increasing the risk of condensate and/or icing developing in the CAC. An additional advantage of the CAC 100 or 200 is that for a given degree of cooling capacity, the CAC can be made physically smaller, and with less weight and material, than what would be required for a CAC that incorporates all smooth style turbulators. This may result in a cost savings in manufacturing the CAC 100. The improved compactness of the CAC 100 may also enable the CAC 100 to be used in locations in an engine compartment where a prior art CAC having the same cooling capability, but which is larger because of its use of only smooth style turbulators, would not be possible.

It should be appreciated that the present disclosure also extends toward using all of one type of turbulator, such as all smooth style turbulators but where two or more of the smooth style turbulators have different internal configurations, for example different internal fin designs or configurations, or alternatively to using all lanced-offset turbulators but where two or more of the lanced-offset turbulators have different internal configurations, for example different fin designs or configurations. Still further, the present disclosure extends to any combination of smooth style and lanced-offset turbulators where one style, or both styles, have dissimilar internal configurations.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. An air air-to-air charge air cooler (CAC) for cooling air supplied to an internal combustion engine, the CAC comprising:
a housing;
a plurality of trays located in the housing;
a first one of the trays including a first turbulator having a first internal configuration; and
a second one of the trays including second turbulator having a second internal configuration different from the first internal configuration.

2. An air-to-air charge air cooler (CAC) for cooling air supplied to an internal combustion engine, the CAC comprising:
a housing;
a plurality of trays located in the housing;
a first one of the trays including a lanced-offset turbulator; and
a second one of the trays including a smooth style turbulator.

3. The CAC of claim 2, wherein at least one additional lanced-offset turbulator is disposed in one of the trays.

4. The CAC of claim 2, wherein at least one additional smooth style turbulator is disposed in one of the trays.

5. The CAC of claim 3, wherein the lanced-offset turbulator and the additional lanced-offset turbulator are located immediately next to one another in the housing.

6. The CAC of claim 4, wherein the smooth style turbulator and the additional smooth style turbulator are positioned immediately adjacent one another in the housing.

7. The CAC of claim 2, further comprising:
an additional plurality of lanced-offset turbulators; and
an additional plurality of smooth style turbulators.

8. The CAC of claim 7, wherein the lanced-offset turbulator and the additional plurality of lanced-offset turbulators are disposed adjacent one another as a group in the housing.

9. The CAC of claim 7, wherein the smooth style turbulator and the additional plurality of smooth style turbulators are disposed adjacent one another as a group in the housing.

10. The CAC of claim 2, further comprising an intake port coupled to the housing for receiving an a flow of air to be cooled by the CAC.

11. The CAC of claim 2, further comprising an outlet port coupled to the housing for discharging an airflow that has passed through the CAC.

12. An air-to-air charge air cooler (CAC) for cooling air supplied to an internal combustion engine, the CAC comprising:
a housing;
a plurality of trays located in the housing;
each one of a first subplurality of the trays including a separate lanced-offset turbulator; and
each one of a second subplurality of the trays, different from the first subplurality of trays, including a separate smooth style turbulator.

13. The CAC of claim 12, wherein ones of the first subplurality of trays are grouped together adjacent one another.

14. The CAC of claim 12, wherein ones of the second subplurality of trays are grouped together adjacent one another.

15. The CAC of claim 12, further comprising an intake port coupled to the housing for receiving an a flow of air to be cooled by the CAC.

16. The CAC of claim 12, further comprising an outlet port coupled to the housing for discharging an airflow that has passed through the CAC.
